(19) United States
(12) Patent Application Publication
(10) Pub. No.: US 2025/0360438 A1
(43) Pub. Date: Nov. 27, 2025

(54) THERMOPLASTIC BASKET STRAINER WITH THREADED JOINTING SYSTEM

(71) Applicant: SAUDI ARABIAN OIL COMPANY, Dhahran (SA)

(72) Inventors: Faisal M. ALSHAMMARI, Dhahran (SA); Sami J. KHALDI, Dhahran (SA); Ahmed A. AL-SHARIF, Dhahran (SA); Saud M. HUWAIMEL, As Salam District (SA); Anwar PARVEZ, Jebel Heights (SA); Joao A. TAVARES, Dhahran (SA); Abdullah S. BAHLAS, Al Khobar (SA)

(73) Assignee: SAUDI ARABIAN OIL COMPANY, Dhahran (SA)

(21) Appl. No.: 18/670,840

(22) Filed: May 22, 2024

(51) Int. Cl. B01D 29/13; B33Y 80/00

(52) U.S. Cl. CPC B01D 29/13; B01D 2201/0415; B33Y 80/00

(57) ABSTRACT

A basket strainer for removing solid particles from liquids including a first strainer module with a first main body, a first end, and a second end. The basket strainer includes a second strainer module with a second main body, a third end, and a fourth end. The basket strainer also includes a third strainer module with a third main body, a fifth end, and a sixth end. The basket strainer includes the first strainer module connected to the second strainer module at the second end of the first strainer module and the third end of the second strainer module. The basket strainer includes the second strainer module connected to the third strainer module at the fourth end of the second strainer module and the fifth end of the third strainer module. Each of the strainer modules are made of a polymer and are porous.

### BACKGROUND

Industrial processes including water treatment, chemical processing, and food and beverage production, may require filtration of water, oily water, and seawater, often at elevated temperatures up to 165° F. (74° C.). Basket strainers are used to remove contaminants from the fluid being processed where it acts as a filter to ensure that the flow is continuous and no damage is caused to parts by impurities. Replacing filters can prove to be a costly resource in the life cycle of a process and may require significant maintenance time, disrupting a process and resulting in undesired downtime. Accordingly, there exists a need for a cost and time efficient basket strainer to ensure effective debris capture with reduced maintenance time while inhibiting corrosion of the basket strainer. Further, the basket strainer must be easily adaptable to varying stream particulate conditions, by varying pore size in the manufacturing process of the basket strainer.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a basket strainer for removing solid particles from liquids. The basket strainer includes a first strainer module, a second strainer module, and a third strainer module. The first strainer module includes a first main body, a first end, and a second end. The second strainer module includes a second main body, a third end, and a fourth end. The third strainer module includes a third main body, a fifth end, and a sixth end. Each of the strainer modules is connected, with the first strainer module connected to the second strainer module at the second end of the first strainer module and the third end of the second strainer module. The third strainer module is connected to the second strainer module at the fourth end of the second strainer module and the fifth end of the third strainer module. Each of the strainer modules is hollow, porous, and made of a polymer. Other aspects and advantages of the claimed subject matter will be apparent from the following description and the appended claims.

### BRIEF DESCRIPTION OF DRAWINGS

FIG. 1A is an illustration of the basket strainer in accordance with one or more embodiments.

FIG. 1B is an exploded view of an illustration of the basket strainer in accordance with one or more embodiments.

FIG. 2A-2C illustrate the end features of the strainer modules in accordance with one or more embodiments.

FIG. 3 is a detailed view of a cross section of the basket strainer in accordance with one or more embodiments.

FIG. 4 is a view of the basket strainer installed into a pipe in accordance with one or more embodiments.

### DETAILED DESCRIPTION

In one aspect, embodiments disclosed herein relate to a basket strainer for removing solid particles from liquids. Embodiments disclosed herein relate to a modular design for the basket strainer, where each strainer module connects to form a single basket strainer.

Each strainer module is porous and hollow to allow fluid containing particulates to flow through the basket strainer. The basket strainer retains solid particulates onto the surface of the basket strainer, while allowing fluid to flow through the porous holes. The effluent from the basket filter is a fluid without specified sizes of particulate matter that are retained on the basket strainer. In some embodiments, some particulate matter may intentionally remain in the fluid if it is smaller than the pore size of the basket strainer. Removing particulate matter from the fluid may protect downstream equipment such as pumps and valves from damage. Additionally, filtration through the basket strainer may remove unwanted particulate matter that may impact downstream reactions or products. In some embodiments, the basket strainer may be used to filter water being supplied to a process to ensure that the supply water does not contain unwanted particulate matter. The basket strainer will require cleaning or replacement due to solid particulate build up or damage to the basket strainer throughout the life cycle of the basket strainer.

Using additive manufacturing, specifically 3D printing, allows for customization, simple manufacturing of the pore/hole size, and utilization of different materials based on the application requirements. In some embodiments, a Selective Lasering Sintering (SLS-type) 3D printer may be used. The hole size may vary based on the application of the basket strainer. The hole size may be easily adjusted based on the particulate size targeted with the basket strainer. Each strainer module is produced via additive manufacturing using a nonmetallic and corrosion resistant material. A polymer may be used as the filament for 3D printing. As is understood by those skilled in the art, a suitable polymer may be selected based on the conditions under which the basket will be employed, and in some particular embodiments, the polymer may be a thermoplastic, such as polyamide PA2200. The polymer may be selected based on compatibility requirements with the fluid and the temperature in the system. In one or more embodiments, the polymer is a thermoplastic material, such as polypropylene (PP), polyvinylidene fluoride (PVDF), and polyether ether ketone (PEEK) or carbon-fiber (CF) reinforced thermoplastic filament based on the higher design temperature and strength requirements. In one or more embodiments, the system temperature may be below 165° F. (74° C.). In other embodiments, conditions around the basket strainer may reach up to 194° F. (90° C.).

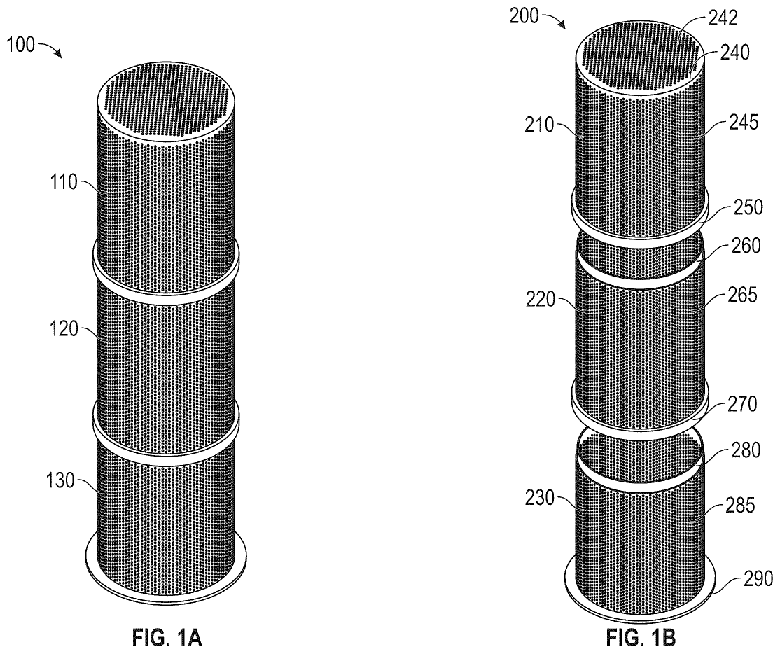

FIG. 1A illustrates the basket strainer 100 in a fully assembled view. In the orientation of FIG. 1A, the first strainer module 110 is connected to the top of the second strainer module 120. The third strainer module 130 is connected to the bottom of the second strainer module 120. Each strainer module is connected via a threaded connection to form a single basket strainer 100.

FIG. 1B illustrates the basket strainer 200 in an exploded view. The first strainer module 210 has a first main body 245, a first end 240, and a second end 250. The first main body 245 is the portion of the first strainer module 210 excluding the end features (i.e., 240 and 250). The first end 240 includes an end cap 242. The second end 250 contains an internally threaded protrusion that extends away from the second end 250 of the first strainer module 210. The second strainer module 220 has a second main body 265, a third end 260, and a fourth end 270. The second main body 265 is the portion of the second strainer module 220 excluding the end features (i.e., 260 and 270). The third end 260 contains an externally threaded protrusion extending away from the third end 260 of the second strainer module 220. The fourth end 270 contains an internally threaded protrusion extending away from the fourth end 270 of the second strainer module 220. The third strainer module 230 has a third main body 285, a fifth end 280, and a sixth end 290. The third main body 285 is the portion of the third strainer module 230 excluding the end features (i.e., 280 and 290). The fifth end 280 contains an externally threaded protrusion extending away from the fifth end 280 of the third strainer module 230. The sixth end 290 of the third strainer module 230 is typically kept open.

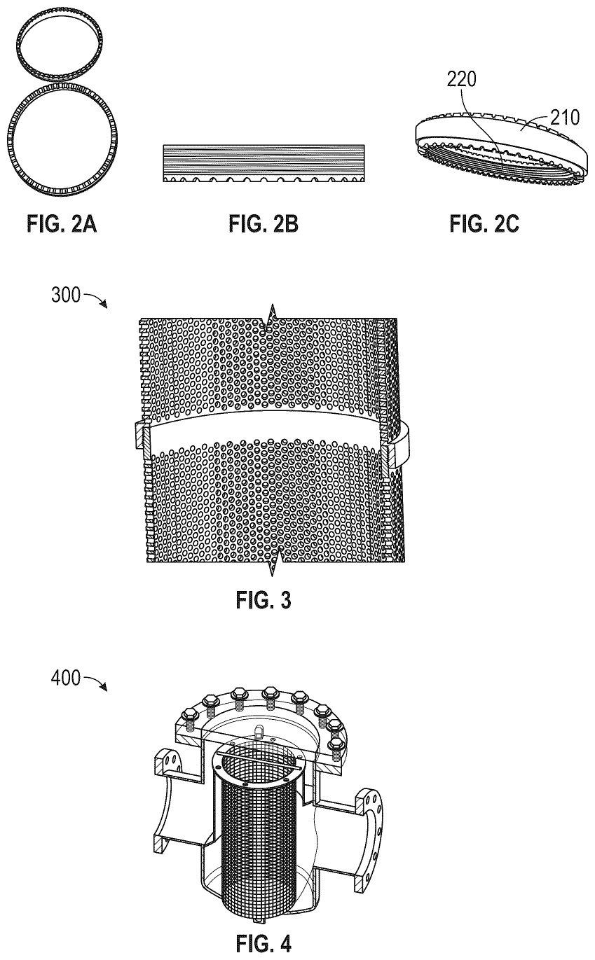

At each connection point, the internally threaded protrusions and the externally threaded protrusions align to lock the strainer modules securely together. The outer diameter of each of the internally threaded protrusions is larger than the outer diameter of each of the main bodies that the internally threaded protrusion extends from. The diameter of the externally threaded protrusions is sized to align within the internally threaded protrusion to properly interlock the strainer modules together. FIG. 2A illustrates the two end features with the externally threaded protrusion and the internally threaded protrusion, where the end feature with an externally threaded protrusion has a smaller diameter to align with the diameter of the end feature with an internally threaded protrusion. FIG. 2B illustrates a closer view of the threading on the externally threaded protrusion on the end feature. FIG. 2C illustrates a closer view of the internally threaded protrusion on the end feature, including both an exterior view 210 and interior view 220. The exterior view 210 illustrates a smooth outer surface. The interior view 220 illustrates the internal threading. In one or more embodiments, the threading is parallel threading. In embodiments requiring high pressures above 300 psig, either PEEK or CF reinforced material may be used with a tapered thread. Polytetrafluoroethylene (PTFE) tape may be utilized as a sealant and for the prevention of galling of the threads.

The overall dimensions of the basket strainer may be chosen for a particular use case or application. In one or more embodiments, the maximum outer diameter of the basket strainer is 12 inches. In one or more embodiments, the maximum total length of the basket strainer is 36 inches. The height of each of the strainer modules, including the protrusions, is in a range of 8 to 12 inches. In embodiments where the total length of the basket strainer is 36 inches, each of the modules is 12 inches in length. In embodiments where the total length of the basket strainer is 24 inches, each of the modules is 8 inches in length. In one or more embodiments, the maximum number of threads per inch is 8 threads per inch.

As noted above, the basket strainer 300 contains pores or holes for allowing fluid to flow therethrough. FIG. 3 is an exemplary embodiment showing a cross section of the basket strainer 300 containing holes. Due to the ability to 3D print the modules, the dimensions of the holes can be tuned and optimized for a particular use case. For example, the pores may be any shape, including round and/or rectangular. Furthermore, the size of the holes may be tuned to trap solid particulates of a particular sides, but allow fluid and smaller particulates to readily flow through. For example, the holes may have a diameter ranging from 2 to 4 mm.

To assemble the basket strainer together, the internally threaded protrusion of the second end (250, FIG. 1B) of the first strainer module (210, FIG. 1B) aligns with the externally threaded protrusion of the third end (260, FIG. 1B) of the second strainer module (220, FIG. 1B). The internally threaded protrusion of the fourth end (270, FIG. 1B) of the second strainer module (220, FIG. 1B) aligns with the externally threaded protrusion of the third strainer module (230, FIG. 1B).

FIG. 4 is a view of the basket strainer 400 installed into a pipe in accordance with one or more embodiments. In FIG. 4, the water flows perpendicularly to the lengthwise axis of the basket strainer 400, allowing the water to flow through the pores of the outer sides of the basket strainer 400.

When damage or solid build up occurs, the basket strainer may be replaced in its entirety or modularly. If a single strainer module is damaged or fouled, the strainer module may be removed and replaced in the system by disconnecting it from the adjacent strainer module. If multiple strainer modules are damaged or fouled, the basket strainer may be removed from the system in a single piece. This modularity allows for flexible and time and cost-efficient maintenance to minimize downtime.

Embodiments of the present disclosure may provide at least one of the following advantages. The modularity of the basket strainer allows for simple maintenance. In single piece basket strainers, the full basket strainer requires replacement when damaged. The modularity of the present disclosure allows for individual replacement of the strainer modules. This results in time- and cost-efficient maintenance activities. Additionally, using additive manufacturing to produce the basket strainer allows for extensive customization of the dimensions and pore size, thus resulting in a highly flexible design.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A basket strainer for removing solid particles from liquids, comprising:
a first strainer module comprising a first main body, a first end, and a second end;
a second strainer module comprising a second main body, a third end, and a fourth end; and
a third strainer module comprising a third main body, a fifth end, and a sixth end;
wherein the first strainer module is connected to the second strainer module at the second end of the first strainer module and the third end of the second strainer module;
wherein the second strainer module is connected to the third strainer module at the fourth end of the second strainer module and the fifth end of the third strainer module;
wherein each of the strainer modules is hollow and porous;
wherein each of the strainer modules is made of a polymer.

2. The basket strainer of claim 1, wherein the first end of the first strainer module comprises an end cap.

3. The basket strainer of claim 1, wherein the first strainer module further comprises an internally threaded protrusion extending away from the second end of the first strainer module.

4. The basket strainer of claim 3, wherein the internally threaded protrusion of the first strainer module has an outer diameter larger than the outer diameter of the first main body of the first strainer module.

5. The basket strainer of claim 1, wherein the second strainer module further comprises an externally threaded protrusion extending away from the third end of the second strainer module.

6. The basket strainer of claim 1, wherein the second strainer module further comprises an internally threaded protrusion extending away from the fourth end of the second strainer module.

7. The basket strainer of claim 6, wherein the internally threaded protrusion of the second strainer module has an outer diameter larger than the outer diameter of the second strainer module.

8. The basket strainer of claim 1, wherein an externally threaded protrusion extends from the fifth end of the third strainer module.

9. The basket strainer of claim 1, wherein the sixth end of the third strainer module is open.

10. The basket strainer of claim 1, wherein each of the strainer modules is produced via additive manufacturing.

11. The basket strainer of claim 1, wherein the polymer is PA2200.

12. The basket strainer of claim 1, wherein a height of each of the strainer modules is in a range of 8 to 12 inches.

13. The basket strainer of claim 1, wherein a thread type for the internally and externally threaded protrusions is parallel.

14. The basket strainer of claim 1, wherein a thread type for the internally and externally threaded protrusions is tapered.

15. The basket strainer of claim 13, wherein a thread size for the internally and externally threaded protrusions is less than or equal to 8 threads per inch.
